(19) United States
(12) Patent Application Publication
(10) Pub. No.: US 2013/0105750 A1
(43) Pub. Date: May 2, 2013

(54) CHAIN WILDCAT, AND ANCHOR HANDLING WINCH PROVIDED WITH SAID CHAIN WILDCAT

(71) Applicant: Geir Hystad, Kopervik (NO)

(72) Inventor: Geir Hystad, Kopervik (NO)

(73) Assignee: KARM AS, KOPERVIK (NO)

(21) Appl. No.: 13/695,894

(22) PCT Filed: Apr. 18, 2011
(86) PCT No.: PCT/NO2011/000132

§ 371 Date: Jan. 7, 2013

(30) Foreign Application Priority Data
May 4, 2010 (NO) 20100639

(51) Int. Cl. B66D 1/72; B63B 21/16; B63B 21/22; B66D 1/54

(52) U.S. Cl. CPC B66D 1/72; B66D 1/54; B63B 21/16; B63B 21/22
USPC 254/372

(57) ABSTRACT

A chain wildcat comprising an intermediate piece with an inner central part about which the chain wildcat can rotate freely after disengagement of a grip configured for attachment to a drive shaft in an anchor handling winch, the intermediate piece comprising an additional central part configured for fixed connection to the drive shaft.

The present invention relates to a chain wildcat for an anchor handling winch, and more specifically it relates to a chain wildcat as disclosed in the preamble of claim 1. The invention further relates to an anchor handling winch equipped with a chain wildcat, as disclosed in the preamble of claim 7.

Put briefly, a wildcat is the drum or wheel that heaves in the chain, where the drum or wheel is advantageously provided with at least five pockets that engage the chain links. Different chain dimensions therefore require the use of different-size pockets.

The international standard ISO 7365 relating to winches for towing and anchor handling vessels refers to emergency release in general without distinguishing between wires and chain, and is therefore regarded as unsuitable or insufficient as regards anchor handling winches equipped with both wire drum and chain wildcat. For a wire drum, it is a requirement that the drum can be placed in neutral within a maximum number of seconds, but for a chain wildcat there is at present so such requirement.

Inadequate requirements for placing a chain wildcat in neutral lead to a risk of an anchor handling vessel foundering, especially when working against the towline, because many anchor handling vessels in that situation have sufficient transverse force to capsize the vessel. This problem is described in more detail by the English textbook author on ship stability, Ian Clark.

On previously known anchor handling winches, the wildcat is typically loose, and is attached to the end of a drive shaft which often has a pentagonal, key or spline connection. The said winches further typically consist of a drive unit which drives the drive shaft, where a disengageable wire drum is connected to the drive shaft, and also where different removable wildcats can be mounted to the end of the drive shaft equipped with a journal so as to enable the vessel to handle several different chain dimensions.

Other systems are previously known where the whole of the drive shaft is disengageable in relation to the drive unit, but as far as the applicant is aware none are known where the wildcat itself can be disengaged from the drive shaft, in an emergency release, for example, to prevent the vessel from capsizing.

As mentioned above, requirements are set as regards the possibility of disengaging the wire drum, but no similar requirements are made as regards disengaging the chain wildcat. To solve the problems this causes, it is an object of the present invention to provide a disengageable chain wildcat which also can be used on existing anchor s handling winches, as disclosed in the characterising clause of claim 1, and an anchor handling winch equipped with a disengageable chain wildcat, as disclosed in the characterising clause of claim 7.

Advantageous embodiments of the invention are set forth in the dependent claims.

The present invention is described in more detail in the following, with reference to the attached drawings of non-limiting exemplary embodiments of the invention, and wherein

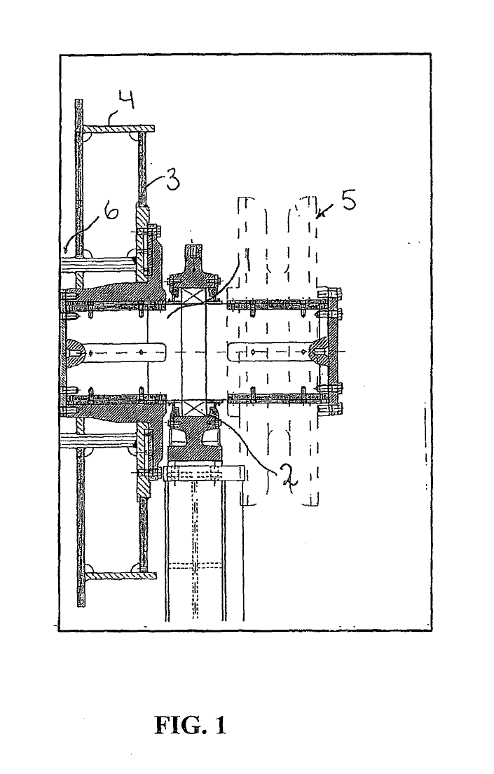

FIG. 1 is a side view of a part of the drive shaft of a prior art anchor handling winch, where attached to the drive shaft is a wire drum connected to a brake drum shown on the left-hand side of the figure, and where on the right-hand side of the figure there is indicated in broken lines a connection of chain wildcat to one end of the drive shaft;

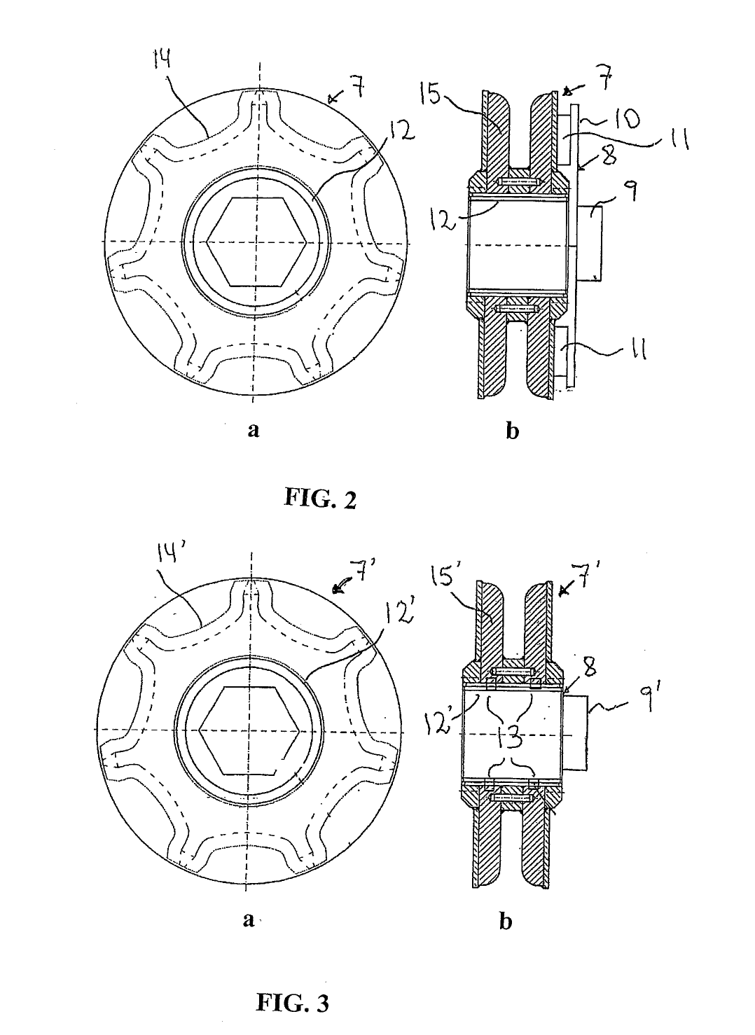

FIGS. 2a and b are respectively a side view and an axial cross-section of a first embodiment of a chain wildcat according to the invention;

FIGS. 3a and b are respectively a side view and an axial cross-section of a second embodiment of a chain wildcat according to the invention.

In the following description, a part or an element of the second embodiment having the same or similar function as a part or element of the first embodiment is indicated by the same reference numeral, but followed by an apostrophe (').

FIG. 1 shows in principle a part of a typical prior art anchor handling winch, and also shows a part of a drive shaft 1, a bearing 2 for the drive shaft 1, and a brake drum 3 with a braking surface 4 for the anchor handling winch secured to a part of the drive shaft 1. Attachment of a chain wildcat 5 to an end of the drive shaft 1 is further indicated in broken lines. The wire drum 6 of the anchor handling winch is only just visible in the figure, and is typically disengageably attached to the drive shaft 1 in association with the brake drum 3. For controlled braking of the anchor handling winch, a non-illustrated brake shoe is brought into variable pressing abutment against the braking surface 4.

FIGS. 2a and b show in principle a first embodiment of a disengageable chain wildcat 7 according to the present invention where between the wildcat 7 and the drive shaft 1 there is arranged an intermediate piece 8 with a sleeve-shaped part 9 fixedly attached to the end of the drive shaft 1, and with a plate-like part 10 radially extending from the sleeve-shaped part 9 for disengageable connection to the wildcat 7. Disengageable fasteners between the wildcat 7 and the intermediate piece are indicated by means of the reference numeral 11 in the figure, and may be hydraulically, pneumatically or electrically activated by input via a non-illustrated swivel or slip ring connection in a way that will be obvious to those of skill in the art in the light of the description and drawings. There will preferably be at least three disengageable fasteners 11 spaced apart equidistantly in a radial direction on the plate-like part 10, and after disengagement of the fasteners 11, the wildcat 7 will rotate freely on another sleeve-shaped part 12 of the intermediate piece 8.

FIGS. 3a and b show in principle a second embodiment of a disengagable chain wildcat 7′ according to the present invention where between the wildcat 7′ and the drive shaft 1 there is arranged an intermediate piece 8′ with a sleeve-shaped part 9′ fixedly attached to the end of the drive shaft 1, and where the intermediate piece 8′ further comprises a non-illustrated control unit, for example, a radio receiver for remote detonation of explosively releasable bolts 13 arranged between the intermediate piece 8′ and the wildcat 7′ with the aid of radio signals, and where, after detonation of the bolts 13, the wildcat 7′ will rotate freely on another sleeve-shaped part 12′ of the intermediate piece 8′.

In both FIGS. 2a and 3a, the pockets 14, 14′ of the chain wildcat 7, 7′ are in respective side walls 15, 15′ and adapted to a given chain dimension indicated in broken lines.

The energy for disengaging the wildcat 7, 7′ may thus either be stored in the wildcat itself or be suppliable via a (non-illustrated) swivel or slip ring, for example, via hydraulic oil, air or as electric current. Stored energy in the wildcat may typically be in the form of (non-illustrated) springs, accumulator, battery or explosive material. This energy may further be controlled at a distance through (non-illustrated) hydraulic, pneumatic, electric, radio, acoustic or mechanical control/transfer. For the actual disengagement, it is conceivable to have in addition to, or instead of, the illustrated detonatable bolts 13, (non-illustrated) shear pins, splines, key connections, hydrodynamic locking devices, friction-braking devices and/or claw couplings.

According to the present invention, increased safety will be obtainable for a towing or anchor handling vessel in that the vessel can be disengaged from the chain line to the same extent as it can be disengaged from a wire line.

The chain wildcat according to the invention is intended to be capable of being retrofitted on existing anchor handling winches, and will thus also increase the safety of these winches.

The invention is not limited to the illustrated embodiments, but can be varied within the is scope of the attached claims.

1. A chain wildcat comprising an intermediate piece with an inner central part about which the chain wildcat can rotate freely after disengagement of a grip configured for attachment to a drive shaft in an anchor handling winch the intermediate piece comprising an additional central part configured for fixed connection to the drive shaft.

2. A chain wildcat according to claim 1, wherein the intermediate piece comprises a plate-like part radially extending from the central part and wherein, between which the plate-like part and the chain wildcat there are provided grips in the form of disengageable fasteners.

3. A chain wildcat according to claim 2, wherein the disengageable fasteners are hydraulically, pneumatically or electrically activated by input via a swivel or slip ring connection, and wherein there are at least three disengageable fasteners spaced apart equidistantly in the radial direction on the plate-like part.

4. A chain wildcat according to claim 1, wherein, characterised in that between the chain wildcat and the inner central part of the intermediate piece, there are provided grips in the form of explosively releasable bolts, the intermediate piece further including a radio receiver for remote detonation of the bolts with the aid of radio signals.

5. A chain wildcat according to claim 1, wherein the grip is in the form of or comprises shear pins, splines, key connections, hydrodynamic locking devices, friction braking devices and/or claw couplings.

6. A chain wildcat according to claim 1, wherein the chain wildcat is configured to be retrofit to an existing anchor handling winch.

7. An anchor handling winch, comprising a chain wildcat according to claim 1.

8. An anchor handling winch according to claim 7, wherein the drive shaft of the anchor handling winch comprises a wire drum to which is connected a brake drum comprising a braking surface.

9. The chain wildcat of claim 1, wherein the chain wildcat can be adapted to function with chains of different dimensions.

10. A method of operating an anchor handling winch comprising:
providing a chain wildcat according to claim 1 and an anchor handling winch, and
using said chain wildcat in association with the anchor handling winch.

11. The method of claim 10, wherein the wildcat is disengaged from a drive shaft of the anchor handling winch to reduce risk in an emergency situation.

12. The method of claim 11, wherein said emergency situation is a danger of vessel capsize.
